(19) United States
(12) Patent Application Publication
(10) Pub. No.: US 2008/0102291 A1
(43) Pub. Date: May 1, 2008

(54) Method for coating a substrate

(75) Inventors: Ashwin A. Hattiangadi, Dunlap, IL (US); M. Brad Beardsley, Laura, IL (US); Mark S. Diekevers, Metamora, IL (US); Michael L. Johnson, Henry, IL (US); Ondrej Racek, Peoria, IL (US); Jason L. Sebright, Chillicothe, IL (US); Steven R. Thompson, Benson, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/589,966

(22) Filed: Oct. 31, 2006

(51) Int. Cl. B32B 15/04; B32B 7/02; B05D 3/00; B05D 3/02; C23C 4/10; B32B 9/00

(52) U.S. Cl. 428/457; 428/212; 428/698; 427/450; 427/374.1; 427/554

(57) ABSTRACT

A method for coating a substrate is disclosed. The method includes applying a coating to a surface of the substrate and heating the applied coating and a first portion of the substrate. The first portion includes the surface of the substrate and less than the entire substrate. The method further includes cooling the applied coating and the first portion.

### TECHNICAL FIELD

The present disclosure relates to coatings and, more particularly, to a method for coating a substrate.

### BACKGROUND

Components that are exposed to corrosive or high wear environments usually include a base material and a coating layer applied thereon. The coating layer usually includes properties or characteristics that are relatively more resistive to corrosion or wear than the base material, and the base material usually includes properties that are relatively stronger or more durable than the coating layer. The coating layer is usually applied to the base material by a coating process such as, for example, high velocity oxygen fuel (“HVOF”) coating. An HVOF process usually includes spraying a stream of high velocity exhaust from a oxygen-fuel torch and injecting powered metal into the exhaust which subsequently melts. The exhaust-powered metal mixture is directed toward the base material, impinges the base material, and forms a mechanical bond as it cools. The mechanically bonded coating layer often exhibits an undesirably short lifecycle because of cracking, spalling, and/or other failure.

U.S. Pat. No. 6,083,330 (“the '330 patent”) issued to Moskowitz discloses a process for forming a coating on a substrate using a stepped heat treatment to metallurgically bond the coating to the substrate. The process of the '330 patent includes cleaning a substrate and applying a coating on the substrate with a HVOF thermal spray process. The process of the '330 patent further includes subjecting the coated substrate to a stepped heat treatment over a time period of several hours. During the stepped heat treatment, the coated substrate is subjected to three required heating steps and an optional fourth step at temperatures of 500° F., 1000° F., 1220° F., and 1400° F. respectively. The substrate is heated from a previous temperature to a new temperature over a 30 minute period and held at the new temperature for an additional 30 minutes. The coated substrate is also subjected to a post heating treatment between a minimum temperature of 1400° F. and a maximum temperature of slightly less than the melting point of the coating for a time period of 0.5 to 24 hours. The process of the '330 patent utilizes a furnace to heat the coated substrate during each of the heat treatment steps and the post heat treatment.

Although the process of the '330 patent may heat treat a coated substrate, the properties and characteristics of the substrate may be altered because the substrate is subjected to the elevated temperatures. Additionally, the time required to heat treat the coated substrate in the process of the '330 patent may be substantially long, undesirably increasing manufacturing time and costs. Furthermore, the process of the '330 patent may produce a diffused bond and may not produce a fused bond.

The present disclosure is directed to overcoming one or more of the shortcomings set forth above.

### SUMMARY OF THE INVENTION

In one aspect, the present disclosure is directed to a method for coating a substrate. The method includes applying a coating to a surface of the substrate and heating the applied coating and a first portion of the substrate. The first portion includes the surface of the substrate and less than the entire substrate. The method further includes cooling the applied coating and the first portion.

In another aspect, the present disclosure is directed to a method for coating a substrate. The method includes applying a metallic coating to a surface of the substrate via a high velocity oxygen fuel coating process. The method also includes locally heating the coating and a first portion of the substrate via one of an induction heating process or a laser heating process. The first portion is adjacent the coating and separates a substantially unheated second portion of the substrate from the coating. The method further includes locally cooling the coating and the first portion by subjecting the coating and the first portion to medium of either compressed air, ambient air, or ambient water.

In yet another aspect, the present disclosure is directed to a coated substrate. The substrate is formed from a metallic material and includes a first portion and a second portion. The coated substrate also includes a coating formed from a metallic material. The coated substrate further includes a metallurgical bond between the substrate and coating. The metallurgical bond is formed by heating the first portion and the coating to a temperature approximately equal to the melting point of the coating.

### BRIEF DESCRIPTION OF THE DRAWINGS

FIG. 1 is a flow chart of an exemplary method for applying a coating in accordance with the present disclosure; and

FIG. 2 is a diagrammatic sectional illustration of an substrate coated according to the method of FIG. 1.

### DETAILED DESCRIPTION

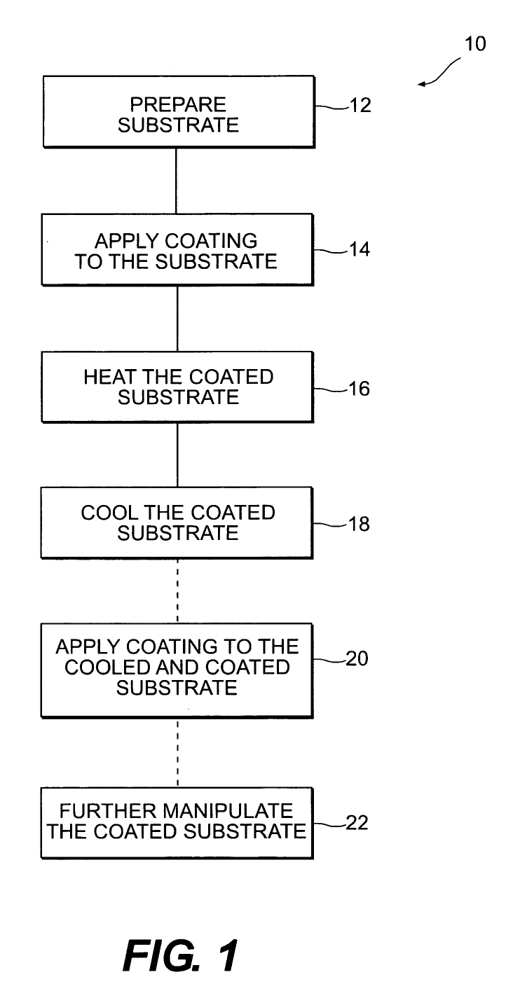

FIG. 1 illustrates an exemplary method 10 for applying a coating. Specifically, method 10 may include preparing a substrate, step 12, and applying a coating, step 14. Method 10 may also include locally heating the coated substrate, step 16, and cooling the coated substrate, step 18. Method 10 may further include manipulating the coated substrate, step 22. It is contemplated that method 10 may be performed continuously, periodically, singularly, as a batch method, and/or may be repeated as desired.

Step 12 may include preparing a substrate. A substrate may include any object, part, or component formed from any metallic based material. Specifically, step 12 may include roughening the surface of the substrate by, for example, grit blasting the substrate, and may include cleaning the surface of the substrate to remove oxides, grease, carburization, and/or other contaminants. It is contemplated that roughening the surface of the substrate may or may not be performed.

Step 14 may include applying a coating to the substrate. A coating may include a metallic material, a cermet material, and/or any other metallic based material known in the art and may be applied to the surface of the substrate to provide desired characteristics thereto. The motivations to apply a coating to a substrate are well known in the art and include, for example, providing a coating material that is relatively more resistive to wear and/or corrosion than the substrate material. It is contemplated that a coating may be applied to the substrate for any motivation known in the art. It is also contemplated that a cermet material may include any percentage of metal and ceramic materials.

Specifically, step 14 may include applying a high velocity oxygen fuel (“HVOF”) coating. HVOF coating processes are well known in the art and may include mixing oxygen and a fuel within a torch apparatus and directing the combustion exhaust thereof through a nozzle. HVOF coating processes may also include delivering a metal powder into the exhaust stream. Each particle of the metal powder may increase in temperature, become molten, and accelerate when exposed to the exhaust stream. HVOF coating processes may also include directing the combined stream of exhaust and metal powder toward the substrate wherein the molten particles may impact the surface of the substrate, build-up, and overlap one another to substantially coat the surface of the substrate, i.e., form a coating on the surface of the substrate. HVOF coating processes may further include allowing the molten build-up of metal powder to cool and form a mechanical bond with the surface of the substrate.

Step 16 may include heating the coated substrate. Specifically, step 16 may include heating the applied coating and a portion of the coated substrate a predetermined distance below the coated surface. That is, step 16 may include locally heating a portion of the substrate that is proximate the coated surface and may include heating the mechanically bonded coating. As such, the heated portion of the substrate and the coating may metallurgically bond to one another. The process by which the mechanical bond between the surface of the substrate and the applied coating transforms into a metallurgical bond at an elevated temperature is well known in the art and, as such, is not further described. It is contemplated that the portion of the distance below the coated surface may be significantly less than the thickness of the substrate with respect to the coated surface. It is also contemplated that step 16 may include locally heating the substrate and the coating substantially simultaneously. It is further contemplated that heating the coating substrate may raise the temperature of the portion of the substrate and the coating around the melting point temperature of the coating, e.g., approximately to and less than or approximately to and greater than the melting point temperature of the coating.

Additionally, step 16 may include locally heating the substrate and coating via an induction heating method or a laser heating method. An induction heating method may include subjecting the coated substrate to an electromagnetic field to vibrate the electrons within the substrate and the coating. An electromagnetic field may be established by passing a electric current through an electromagnetic coil and vibration of the electrons may increase the temperature of the substrate and coating. A laser heating method may include subjecting the coated substrate to an optically focused light beam on the surface of the coated substrate. The focused light beam transfers heat therefrom to the coated substrate. A light beam may be established by focusing a light source with one or more lenses. Induction and laser heating methods are know in the art and, as such, are not further described. It is contemplated that step 16 may additionally or alternatively include a plasma thermal arc heating method and/or any other non mechanical contact heating method known in the art. It is also contemplated that the locally heated portion of the substrate may be adjusted by adjusting one or more parameters of the induction or laser heating methods, such as, for example, adjusting the time the coated substrate is heated, adjusting the spacing between the heat source, e.g., the electromagnetic coil or the light source and the substrate, and/or adjusting other parameters thereof. It is further contemplated that locally heating the coated substrate to approximately the melting point of the coating by either an induction and/or a laser heating method may require less than approximately 60 seconds.

Step 18 may include cooling the coated substrate. Specifically, step 18 may include establishing the material properties, e.g., hardness, within the coated and heated portion of the substrate. For example, the given material properties of the substrate may change during step 16 as a function of the increased temperature affecting the molecular structure of the substrate. For example, heating the coated substrate may result in the heated portion of the substrate changing from a pre-heating phase structure to a martinsitic phase structure. As such, step 18 may include controlled cooling to approximately reestablish the pre-heating phase structure of the heated portion of the substrate. Additionally, step 18 may include establishing a tempered zone within the locally heated portion of the substrate. It is contemplated that the hardness of the coating and the substantially unheated portion of the substrate may be any magnitude and that the tempered zone of the locally heated portion may be less than hardness of each of the coating and the substantially unheated portion.

Specifically, step 18 may include subjecting the coated and heated substrate to cooling processes, e.g., a bath or stream of compressed or ambient air, a bath or stream of compressed or ambient water, a bath or stream of other cooling mediums, and/or other cooling processes known in the art. It is contemplated that step 18 may additionally include quenching the coated and heated substrate via any suitable quenching process known in the art. It is also contemplated that step 18 may include locally cooling the coated and heated substrate, i.e., cooling the locally heated portion of the substrate without substantially affecting the temperature and/or material properties of the remainder of the substrate.

Step 20 may include applying an additional coating layer to the cooled and coated substrate. Specifically, step 20 may include applying a coating that includes a metallic material, a cermet material, and/or any other metallic based material known in the art and the coating layer may be applied via any coating process, such as, for example an HVOF coating process. For example, the material of the coating layer and the coating process of step 20 may or may not be the same as those of the coating layer of step 14. It is contemplated that step 20 may or may not be performed in method 10 and, if not performed, the desired thickness of the coating layer may be applied during step 14. It is also contemplated that method 10 may, if step 20 is performed, provide a coated substrate including a coating layer established in two coating steps, e.g., steps 14 and 20. As such, the thickness of the coating layer applied in step 14 may be less than a desired coating layer thickness and the combined thickness of the coating layer applied in steps 14 and 20 may establish the desired coating layer thickness. It is also contemplated that the surface of the coating layer applied during step 14 may be cleaned to remove oxides, grease, carburization, and/or other contaminants. It is further contemplated that the coating layer applied during step 20 may not be locally heated and cooled and thus may not have its material properties affected by such processes.

Step 22 may include further manipulating the coated substrate. Specifically, step 22 may include machining, polishing, and/or other machining processes known in the art. It is contemplated that step 22 may establish predetermined and/or desired dimensions of the coated substrate and/or thickness of the coating. It is also contemplated that step 22 may selectively be omitted from method 10.

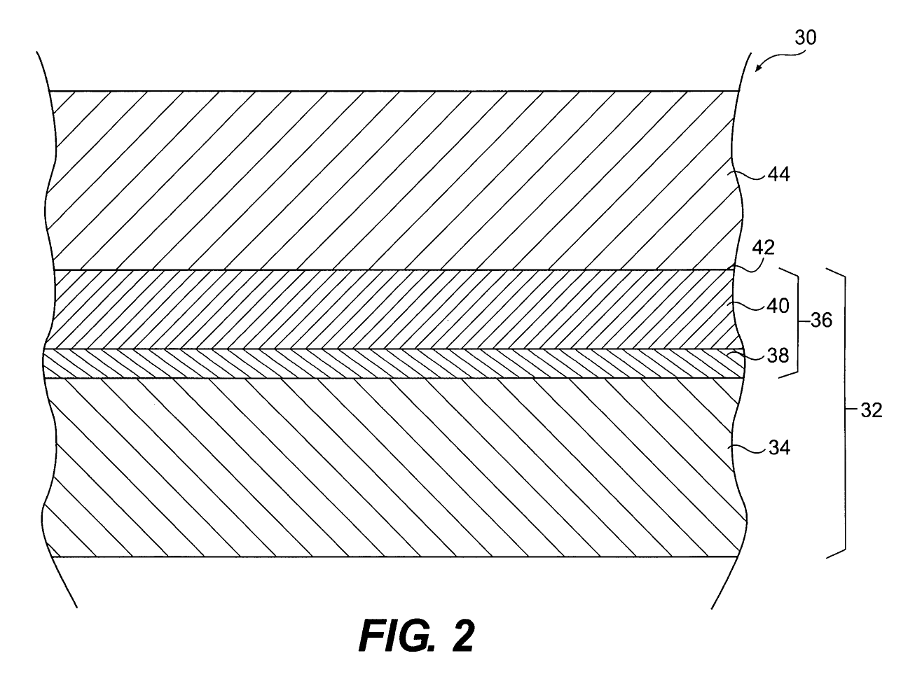

FIG. 2 illustrates an exemplary cross sectional segment of a coated substrate 30 provided by performing one or more steps of method 10. Coated substrate 30 may include a substrate 32, a metallurgical bond 42, and a coating 44. Substrate 32 may include any metallic material and may also include a substantially unheated portion 34 and a locally heated portion 36. Coating 44 may include any metallic and/or cermet material and may be an HVOF applied coating. Coating 44 may or may not include more than one applied layer, e.g., a layer applied during step 14 and another layer applied during step 20. Locally heated portion 36 may be an induction or laser heated portion of substrate 32 and may include a tempered zone 38 and an un-tempered zone 40. Metallurgical bond 42 may be a microstructurally bonded and fused joint formed between locally heated portion 36 and coating 44 by substantially simultaneously increasing the temperature of the locally heated portion 36 and coating 44. It is contemplated that the material phase structure of locally heated portion 36 and substantially unheated portion 34 may be substantially similar. It is also contemplated that tempered zone 38 may include a hardness that is less than a hardness of un-tempered zone 40 and less than a hardness of unheated portion 34 and that the thickness of tempered zone 38 may vary from approximately 0.25 mm to approximately 10 mm. It is further contemplated that the thickness of metallurgical bond 38 may vary from less than 1 micron to greater than 22 microns.

### INDUSTRIAL APPLICABILITY

The disclosed method of applying a coating may be applicable to apply a metallic or cermet coating to a metallic substrate. The disclosed method may provide a metallurgical bond between a coating and a substrate by locally heating and cooling a portion of the substrate. The operation of method 10 is explained below.

A component or part of an assembly may be exposed to a relatively high wear and/or highly corrosive environment and may require given material properties to resist deterioration within such an environment. Forming the entire component or part from material having the given material properties may be undesirably expensive and/or may undesirably sacrifice other desirable properties, e.g., strength or fatigue resistance, to establish the wear or corrosive resistant properties. As such, coating a substrate formed from a first material and applying a coating of a second material may provide a component having substantially all of the desired properties.

Referring to FIGS. 1 and 2, coated substrate 30 may be formed by applying coating 44 to substrate 32 according to method 10. Specifically, substrate 32 may be prepared by cleaning the surface thereof from contaminants, such as, for example, oxides, carburization, and/or grease (step 12). Substrate 32 may also be roughened via a grit blasting process to provide mechanical variations in the surface thereof to improve the adhesion of coating 44. Coating 40 may be applied to substrate 32 via an HVOF process or other coating process (step 14). The coating process, e.g., the HVOF coating process, may establish a mechanical bond between coating 44 and substrate 32. It is contemplated that substrate 32 may be preformed to a particular or desired dimensions, i.e., the component may be machined to a given size and shape before being prepared.

To establish metallurgical bond 42 between coating 44 and substrate 32, the coated substrate 30 may be locally heated (step 16). Specifically, locally heated portion 36 of substrate 32 and coating 44 may be heated to a temperature of approximately the melting point temperature of coating 44. Locally heated portion 36 and coating 44 may be heated via an induction heating process, a laser heating process or other non-mechanical contacting heating process, the parameters of which may be controlled to adjust the amount of substrate 32 that may be locally heated. By heating a portion of the substrate and the coating, metallurgical bond 42 may be formed therebetween as is known in the art. It is contemplated that locally heated portion 36 may include the surface of substrate 32 on which coating 44 may be applied and extends through substrate 32 a distance less than the thickness of substrate 32.

Locally heated portion 36 may, after being heated, include one or more material properties that are dissimilar to substantially unheated portion 34 of substrate 32. That is, locally heated portion 36 may transition to a different material phase or molecular structure as a function of being heated. As such, locally heated portion 36 and coating 44 may be locally cooled (step 18). For example, coated substrate 30 may be exposed to a bath or stream of compressed or ambient air, compressed or ambient water, and/or other cooling medium, to reduce the temperature of coating 44 and locally heated portion 36. It is contemplated that the local cooling process may establish the material phase structure of locally heated portion 36 as substantially similar to the material phase structure of substantially unheated portion 34. It is also contemplated that step 18 may establish tempered zone 38 within locally heated portion 36 as is known in the art. It is further contemplated that the local cooling process may additionally include a quenching process.

Coating 44 may include a second coating layer (step 20) applied to the surface of the coating applied within step 14. The second coating layer may establish the desired thickness of coating 44, which may not be subjected to heating and cooling steps and which may or may not include an interface with the coating applied within step 14. The coated substrate 30 may be further manipulated to establish the final dimensions of the component and/or establish a predetermined thickness of the coating (step 22). The manipulation may include polishing or machining the component to any desired size, shape, or surface conditions as desired. As such, coated substrate 30 may establish a component having one or more desired properties for the component to withstand a high wear and/or highly corrosive environment.

Because method 10 may locally heat a portion of the substrate, a metallurgical bond may be formed therebetween in a relatively shorter amount of time as compared to heating the entire substrate. Additionally, because method 10 may locally cool the substrate, the material phase structure of the locally heated portion that may have been altered during the local heating process may be substantially restored.

It will be apparent to those skilled in the art that various modifications and variations can be made to the disclosed method for coating a substrate. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for coating a substrate comprising
applying a coating to a surface of the substrate;
heating the applied coating and a first portion of the substrate, the first portion including the surface of the substrate and including less than the entire substrate; and
cooling the applied coating and the first portion.

2. The method of claim 1, wherein applying a coating includes applying a metallic or cermet coating via a high velocity oxygen fuel coating process.

3. The method of claim 1, further including removing at least one of oxide, carburization, or grease from the surface before applying the coating to the surface.

4. The method of claim 1, wherein heating and cooling the first portion of the substrate establishes first and second zones within the first portion;
the first zone disposed between the applied coating and the second zone; and
a hardness of the second zone is less than a hardness of the coating and a hardness of the portion of the substrate not included in the first portion.

5. The method of claim 1, further including forming a metallurgical bond between the applied coating and the substrate via the heating of the applied coating and the first portion.

6. The method of claim 1, further including heating the first portion via one of an electric induction heating process or a laser heating process.

7. The method of claim 1, further including cooling the applied coating and first portion via a quenching process after heating the applied coating and first portion.

8. The method of claim 7, further including applying another coating to a surface of the applied coating.

9. A method for coating a substrate comprising:
applying a cermet coating to a surface of the substrate via a high velocity oxygen fuel coating process;
locally heating the coating and a first portion of the substrate via one of an induction heating process or a laser heating process, the first portion being adjacent the coating and separating a substantially unheated second portion of the substrate from the coating; and
locally cooling the coating and the first portion by subjecting the coating and the first portion to medium of either compressed air, ambient air, or ambient water.

10. The method of claim 9, further including forming a metallurgical bond between the coating and the substrate when locally heating the coating and the first portion.

11. The method of claim 9, wherein locally cooling the coating and the first portion includes quenching the coating and the first portion.

12. The method of claim 9, wherein the locally cooled first portion includes a material phase structure that is substantially similar to the substantially unheated second portion.

13. The method of claim 9, wherein locally heating the coating and the first portion includes performing an induction heating process.

14. The method of claim 9, wherein locally heating the coating and the first portion includes performing a laser heating process.

15. The method of claim 9, wherein locally heating the applied coating and the first portion is performed for less than 60 seconds.

16. The method of claim 9, further including:
removing oxide, carburization, or grease from the surface before applying the metallic coating; and
machining or polishing the substrate after locally cooling the applied coating and the first portion.

17. The method of claim 9, further including applying a second coating to a surface of the applied coating and not subjecting the second coating to a locally heating and a locally cooling process.

18. A coated substrate comprising:
a substrate formed from a metallic material and including a first portion and a second portion;
a coating formed from a cermet material; and
a metallurgical bond between the substrate and coating, formed by heating the first portion and the coating to a temperature approximately equal to the melting point of the coating.

19. The substrate of claim 18, wherein:
the first portion includes a first zone having a first hardness and a second zone have a second hardness;
the second portion includes a third hardness; and
the first hardness is less than each of the second and the third hardness.

20. The substrate of claim 18, wherein the coating and the first portion are each heated via either an induction or laser heating method and subsequently cooled.
